(19) United States
(12) Patent Application Publication
(10) Pub. No.: US 2021/0204534 A1
(43) Pub. Date: Jul. 8, 2021

(54) TRANSPORTATION CONTAINER FOR A MODULAR FISHING ROD

(71) Applicant: COMPOSITE DEVELOPMENTS NZ LIMITED, Auckland (NZ)

(72) Inventor: Thomas Leo JOHANSON, Auckland (NZ)

(21) Appl. No.: 17/058,757

(22) PCT Filed: May 28, 2019
(86) PCT No.: PCT/NZ2019/050056

§ 371 Date: Nov. 25, 2020

(30) Foreign Application Priority Data
May 28, 2018 (NZ) 742951

(51) Int. Cl. A01K 97/08; A01K 87/00

(52) U.S. Cl. CPC A01K 97/08; A01K 87/00

(57) ABSTRACT

As a result of the development of a range of modular fishing rods, has become possible to produce a number of different rod styles from a relative small number of modular fishing rod components. Alongside this development is the growing trend of people interested in fishing to travel and to explore different fishing experiences. This has created a need for a safe and convenient way to store and transport modular fishing rods, or rod sets. Disclosed is a transportation container for a modular fishing rod primarily including four hinged panels that can be opened out to gain easy access, and then folded together to provide a strong carry case having a rigid triangular cross section. The container has an inside surface that can secure parts of a modular fishing rod in a spaced apart arrangement and/or secure inserts having slots which perform a similar function.

### FIELD OF THE INVENTION

This invention relates to a transportation container for a modular fishing rod, and in particular, but not exclusively to a transportation container for transporting a modular fishing rod by post or by courier, or when travelling by car, bus or airplane.

### BACKGROUND

Fishing is a rapidly growing pastime or sport for many, as well as being a means for gathering food for others. Fishing rods are often used to catch fish and there is an ever increasing number of styles of fishing rod available. Currently the range of fishing rod types includes; casting rods, surf rods, fly fishing rods, river and lake rods, spinning rods, jigging rods, game fishing rods, etc.

And within the various types of rods that are being used, there are different methods of construction, including one-piece rods, telescoping rods and travel rods made of a number of modules. And because fishing often involves travel, particularly recreational fishing where people enjoy experiencing different locations and types of fishing, it is often convenient to use modular rods because they are not too long when disassembled, but perform well when assembled.

The components that form a modular fishing rod are sometimes placed in a custom made carry bag to ensure that the parts are all kept together. However, contact between the modules whilst in transit can cause problems such as damage that is caused by chafing. Whilst this problem has been addressed to some extent by the use of custom made bags that are designed to keep the projecting parts from each module away from other modules, such bags are limited in that they cannot be used to accommodate a range of styles of fishing rods, for example rods having different sized reels, different numbers of modules, different sized and positioned line guides, etc.

In addition to the increased variety of rods, in recent times there has been a rise in the occurrence of on-line purchases of specialty rods which has created a need for a suitable container to safely and efficiently ship the modular rods to the customers. Such containers need to be sized correctly, be relatively strong and durable to protect the components, be relatively light weight and compact to avoid adding too much to the shipping costs, and have a design that allows a range of modular fishing rod types to be accommodated within the container whilst at the same time keeping each module separate from the other.

And, ideally such a container should be re-usable, to avoid unnecessary waste, and to provide a useful long term storage and transportation container for fishing rods. Parts of a modular fishing rod kit can become mislaid when in storage or when travelling, and sometimes during use of the equipment. Fishing is often carried out from boats, jetties, rocks, river banks etc., so it would also be helpful if such a re-use transportation container could provide secure and safe storage and also provide rapid and clear access to the modules of a fishing rod.

In cases where the components of a modular fishing rod can be used to create a range of fishing rod styles or models, clear access to the components is important. Otherwise time is lost having to sort through the components to find the particular ones that are needed for that a fishing spot or fishing style. In such cases it is also helpful if all of the components can be laid out and can all be seen individually, not only to help locate the desired components quickly, but also to help check that all of the components have been returned when finished, to help ensure that none of the parts of the kit are lost or left behind.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a transportation container for a modular fishing rod which will at least go some way towards overcoming one or more of the above mentioned problems, or at least provide the public with a useful choice.

### STATEMENTS OF THE INVENTION

Accordingly, in a first aspect, the invention may broadly be said to consist in a transportation container for a modular fishing rod, the transportation container having four panels; a base panel, a first side panel, a second side panel, and a closure panel; each of the said four panels being elongate panels and being connected at least one other of the said panels by a hinged line of connection; the closure panel overlying one of the first panel or the second panel when the transportation container is in a closed configuration; and the transportation container also having two or more container inserts configured to receive and to hold sections of a modular fishing rod in a spaced apart arrangement, the or each container insert being connectable to the base panel.

Preferably the first side panel is connected both to the base panel and to the second side panel with a hinged line of connection, and the closure panel is connected to the base panel with a hinged line of connection.

Preferably the hinged line of connections are each situated along a long edge of each of the elongate panels.

Preferably a connected assembly comprising the base panel, the first side panel, the second side panel, and the closure panel, form a shell of the transportation container.

Preferably the transportation container has a substantially triangular cross section when the transportation container is in the closed configuration.

Preferably the base panel, the first side panel and the second side panel are each substantially flat panels.

Preferably the closure panel is a substantially flat panel.

Preferably the said four panels of the transportation container are capable of lying substantially within a single plane when the transportation container is in an open configuration.

Preferably the closure panel substantially overlies the second side panel when the transportation container is in the closed configuration.

Preferably the transportation container further includes a latching mechanism configured to hold the closure panel in a closed position when the transportation container is in the closed configuration.

Preferably the latching mechanism includes a magnetic fastening means.

Preferably each container insert has a substantially triangular shape.

Preferably each container insert is made from a foamed plastics material.

Preferably each container insert has a plurality of spaced apart slots into which modules of a modular fishing rod can be inserted.

Preferably the spaced apart slots each have slot openings in a first edge or face, and in a second edge or face, of each container insert.

Preferably each container insert is connectable to the base panel using a hook and loop style fastening system.

Preferably at least a part of an inside face of some or all of the four panels is covered in a material that is suitable for use as a part of a hook and loop style fastening system.

Preferably the inside faces of the base panel, the first side panel and the second side panel, are each substantially covered in a material that is suitable for use as a part of a hook and loop style fastening system.

Preferably each container insert has a base edge or face that is connectable to the base panel.

Preferably the first side panel lies adjacent the first edge or face of each container insert, and the second side panel lies adjacent the second edge or face of each container insert when the transportation container is in the closed configuration.

Preferably the transportation container further includes two end panels, with one end panel being situated at each end of the transportation container, each end panel being configured to provide closure at an end of the transportation container when the transportation container is in the closed configuration.

Preferably the two end panels form a part of the shell of the transportation container.

Preferably the two end panels are connected to the base panel.

Preferably the transportation container further includes a carry strap.

In a second aspect, the invention may broadly be said to consist in a modular fishing rod kit incorporating at least one transportation container for a modular fishing rod substantially as specified herein and at least one modular fishing rod.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

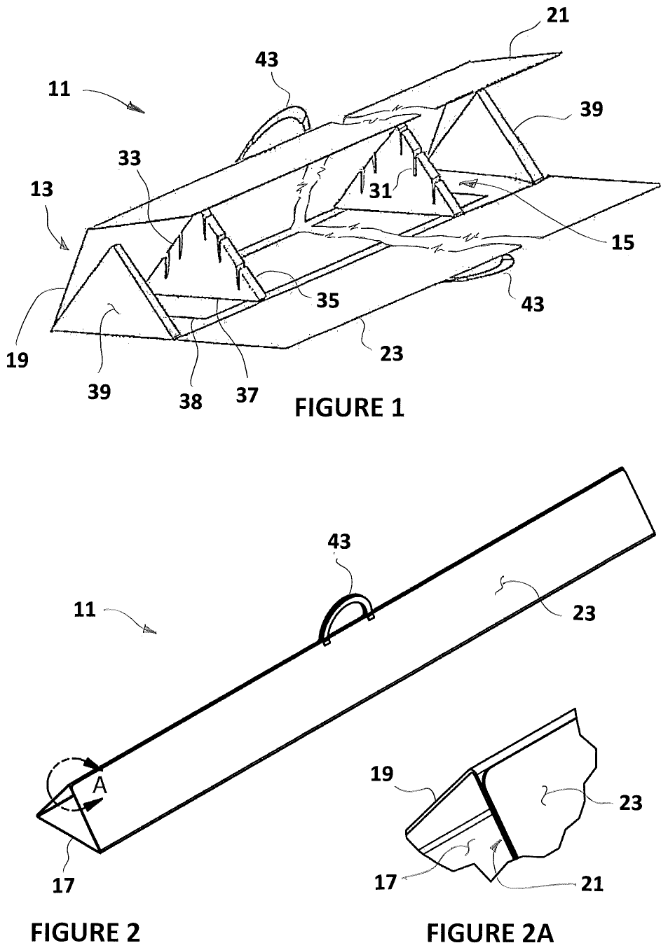

FIG. 1 is a perspective view of a transportation container for a modular fishing rod according to the present invention,

FIG. 2 is a perspective view of the transportation container in a closed configuration and in which a detailed view ‘A’ is defined,

FIG. 2A is a detailed perspective view A as defined in FIG. 2,

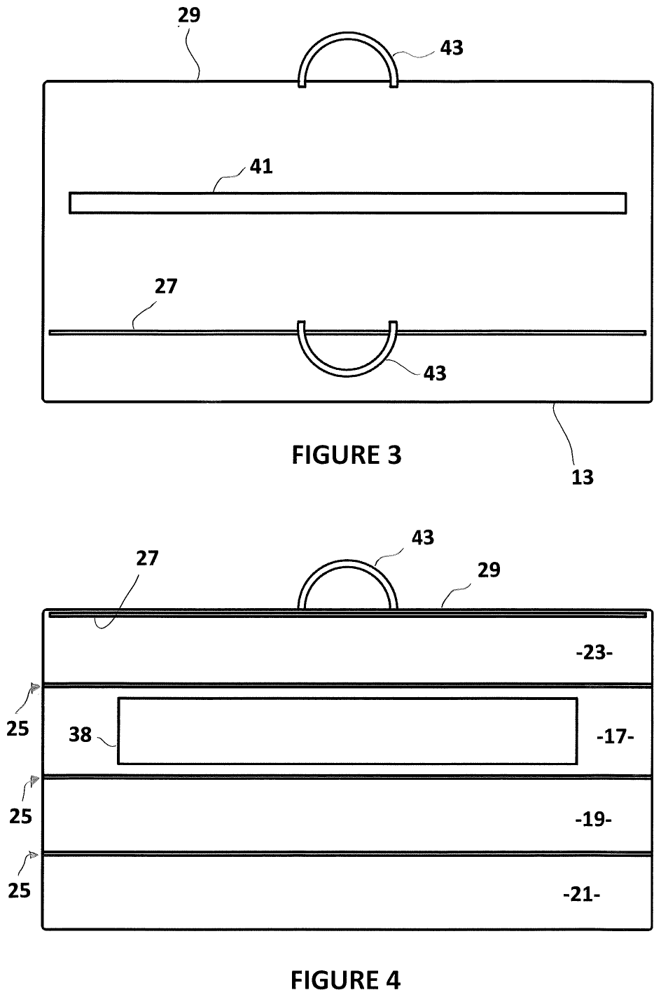

FIG. 3 is a plan view of an outside of a shell of the transportation container for a modular fishing rod, and

FIG. 4 is a plan view of an inside of the shell of the transportation container for a modular fishing rod.

With reference to FIGS. 1 to 4, a transportation container for a modular fishing rod (11) according to the present invention will now be described. The transportation container for a modular fishing rod (11) has been designed for use in housing, protecting and transporting a modular fishing rod kit. All of the parts of one or more modular fishing rods can be individually fitted into the transportation container to keep the parts together to prevent parts becoming lost, while at the same time maintaining space between adjacent parts of the kit to prevent chafing or other damage during transportation. The transportation container also provides easy access to the component parts of the fishing rod kit, and safe storage of any parts that are not being used, whilst out on fishing ventures.

The transportation container for a modular fishing rod (11) is in the form of a fold up shell (13) and a number of container inserts or internal bulkheads (15). The shell (13) provides a protective covering of the parts of a modular fishing rod kit, and the container inserts (15) keep the component parts of the kit separate from one another.

The shell (13) is made up of a connected assembly comprising four connected panels, these being a base panel (17), a first side panel (19), a second side panel (21), and a closure panel (23). Each of these four panels are substantially rectangular and are elongate panels and they are connected to form the shell (13) by a hinged line of connection (25) between each adjacent panel. Each of the three hinged lines of connection (25) are situated along the long edges of each of the elongate panels. The hinged lines of connection (25) can include a hinge or hinges, but can also simply be formed as a thinner of flexible line of the material forming the panels. For example the hinged lines of connection (25) could be made from a fabric cover that is part of each panel, or of a zone of reduced thickness of a plastics material that is used to form the panels or the entire shell (13).

In this example, when the transportation container (11) is in a closed configuration the closure panel (23) overlies the second panel (21) as shown in FIG. 2A. Depending on the configuration of the shell, the closure panel (23) could alternatively overly the first panel (21).

Also, in this example, it can be seen that the first side panel (19) is connected both to the base panel (17) and to the second side panel (21) with a hinged line of connection (25), and the closure panel (23) is connected to the base panel (17) with another hinged line of connection (25). From this construction, it can be seen that the four panels can be folded up, with the closure panel (23) overlying the second panel (21), to form a transportation container (11) that has a substantially triangular cross section when the transportation container is in the closed configuration, as shown in FIGS. 1 and 2.

In FIGS. 3 and 4 it can be seen that the base panel (17), the first side panel (19), the second side panel (21) and the closure panel (23) are all substantially flat panels, and that when the transportation container is in an open configuration, all of the panels are capable of lying substantially within a single plane. This is advantageous when fitting component parts into the transportation container (11) as it allows very clear access to the container inserts (15).

The transportation container (11) further includes a latching mechanism (27) configured to hold the closure panel (23) in a closed position against the second side panel (21) when the transportation container (11) is in the closed configuration. In this example, the latching mechanism (27) includes magnetic fastening means in the form of a magnetic strip along an inside face of a long free edge (29) of the closure panel (23) and a complementary strip of magnetic material on an outer part of the second side panel (21) adjacent to the connection between the second side panel (21) and the first side panel (19).

In this example the transportation container (11) has two container inserts (15) that are substantially triangular in shape, and which are configured to receive and to hold sections of a modular fishing rod, and to hold them in a spaced apart arrangement.

Each container insert or internal bulkhead (15) is made from a foamed plastics material and has a plurality of spaced apart slots (31) into which modules of a modular fishing rod can be inserted. The spaced apart slots (31) each have slot openings in a first edge or face (33), and in a second edge or face (35), of each container insert (15).

The container inserts (15) are connectable to the base panel (17) along a base edge or face (37) of each container insert (15) using a VELCRO™ or hook and loop style fastening system. A wide strip (38) of one part of a VELCRO™ or hook and loop style fastening system is attached to an inside face, and along a greater part of the length, of the base panel (17). As can be seen in FIG. 4, the wide strip (38) covers the greater part of the area of an inside face or internal surface of the base panel (17).

A complementary section of a VELCRO™ or hook and loop style fastening system is also attached to the base edge or face (37) of each container insert (15). In this way, the container inserts (15) can be positioned as desired along the length of the base panel (17) to suit the fishing rod components that are being fitted inside the transportation container (11).

When the transportation container (11) is in the closed configuration, the first side panel (19) lies adjacent the first edge or face (35) of each container insert (15), and the second side panel (21) lies adjacent the second edge or face (37) of each container insert (15).

The transportation container (11) further includes two end panels (39), with one end panel (39) being situated at each end of the transportation container (11). Each end panel (39) is configured to provide closure at each end of the transportation container (11) when the transportation container (11) is in the closed configuration. The end panels (39) are omitted in FIG. 2 for visual purposes only to allow the arrangement of the four panels to be clearly seen.

The two end panels (39) are connected to the base panel (17) and form a part of the shell (13) of the transportation container (11). The two end panels (39) can be made of a solid material such as wood or dense foamed plastics material that is glued or otherwise fastened to the base panel (17). Or alternatively the two end panels (39) can be formed as a part of the base panel (17) or of the rest of the shell (11) and be made from the same plastics, or foamed plastics material. The two end panels (39) can have a connection to the base panel (17) in the form of a hinged joint to allow the shell (11) to fold completely flat for shipping and storage of empty transportation containers (11), or alternatively the two end panels (39) can have a rigid connection to the base panel (17) to keep the process of closing the transportation container (11) as simple as possible.

It can be seen in FIG. 3 that the transportation container (11) further includes a carry strap (41). The carry strap (41) is attached to a point near each end of the base panel (17), and on the outside of the base panel (17), and can be used to carry the transportation container (11) by hand or over a shoulder.

The transportation container (11) also includes a handle (43), the handle (43) being in two halves, a first half attached to the closure panel (23) adjacent to a free edge of the closure panel (23), and a second half being connected to the first side panel (19) adjacent to a connection between the first side panel (19) and the second side panel (21). The halves of the handle (43) being adjacent one another when the transportation container (11) is in its closed configuration.

### VARIATIONS

Aspects of the present invention have been described by way of example only and it should be appreciated that modifications and additions may be made thereto without departing from the scope thereof.

In the transportation container (11) described herein, the transportation container (11) has just two container inserts (15), however it is envisaged that in an alternative configuration a similar transport container could have three or more container inserts (15). It is also envisaged that the end panels (39) could be incorporated into two of the container inserts (15), that is, two of the container inserts (15) could double as end panels (39) that also provide support for items within the transportation container (11).

It is also envisaged that an inside face of the first and second side panels (19) and (21) can also have a hook and loop style fastening system that can engage with a complementary hook and loop style fastening system on the first and second edges (33) and (35) of the container inserts (15) to help stabilise the container inserts (15) when the transportation container (11) is closed and is being used as a storage container or for transportation.

In a further variation, the inside faces of the base panel, the first side panel and the second side panel, can each be covered, or substantially covered, in a material that is suitable for use as a part of a hook and loop style fastening system. For example, the inside faces of the base panel, the first side panel and the second side panel can each be covered in a loop style fabric which will adhere to a patch of hook material when the two are brought into contact.

In this way, the container inserts (15) can be located anywhere inside the transportation container (11). And as an alternative to the use of the container inserts (15), the parts of a fishing rod can be furnished with small sections of hook material adhered to their surface, or with sleeves of hook material about the parts of the fishing rods. In such a case, the parts of the fishing rod can each be individually secured directly onto the inside faces of the base panel, the first side panel and/or the second side panel, by engaging the hook material with the loop material on the inside faces of the transportation container (11). In this way, the parts of the fishing rod are each held securely and separately within the transportation container (11) when it is closed, and they become laid out and accessible when the transportation container (11) is opened out and laid flat.

### Definitions

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a transportation container for a modular fishing rod which has one or more of the following advantages;
it is relatively compact in size and light weight making it suitable for shipping purposes, i.e. for the shipping of internet purchases,
it has a triangular shape and is made of folded panels and this configuration gives an inherent rigidity that provides protection for parts of a fishing rod,
the design offers flexibility in terms of insert design and insert positioning which enables the transportation container to easily accommodate a range of different types of rods,
the design also allows fishing rod parts to be secured directly to an inside surface of the container for simple, spaced apart storage and ease of access,
the configuration provides separation between components and helps to minimize damage that may occur as a result of contact or chafing between components,
the transportation container provides easy access to any components housed by the transportation container when the shell is opened out flat, and/or
the shell opens out flat for compact storage and easier transportation of empty transportation containers.

1. A transportation container for a modular fishing rod, the transportation container having four panels; a base panel, a first side panel, a second side panel, and a closure panel; each of the said four panels being elongate panels and being connected at least one other of the said panels by a hinged line of connection; the closure panel overlying one of the first panel or the second panel when the transportation container is in a closed configuration; and the transportation container also having two or more container inserts configured to receive and to hold sections of a modular fishing rod in a spaced apart arrangement, the or each container insert being connectable to the base panel.

2. The transportation container for a modular fishing rod as claimed in claim 1, wherein the first side panel is connected both to the base panel and to the second side panel with a hinged line of connection, and the closure panel is connected to the base panel with a hinged line of connection.

3. The transportation container for a modular fishing rod as claimed in claim 1, wherein the hinged line of connections are each situated along a long edge of each of the elongate panels.

4. The transportation container for a modular fishing rod as claimed in claim 1, wherein a connected assembly comprising the base panel, the first side panel, the second side panel, and the closure panel, form a shell of the transportation container.

5. The transportation container for a modular fishing rod as claimed in claim 1, wherein the transportation container has a substantially triangular cross section when the transportation container is in the closed configuration.

6. The transportation container for a modular fishing rod as claimed in claim 1, wherein the base panel, the first side panel and the second side panel are each substantially flat panels.

7. The transportation container for a modular fishing rod as claimed in claim 1, wherein the closure panel is a substantially flat panel.

8. The transportation container for a modular fishing rod as claimed in claim 1, wherein the said four panels of the transportation container are capable of lying substantially within a single plane when the transportation container is in an open configuration.

9. The transportation container for a modular fishing rod as claimed in claim 1, wherein the closure panel substantially overlies the second side panel when the transportation container is in the closed configuration.

10. The transportation container for a modular fishing rod as claimed in claim 1, wherein the transportation container further includes a latching mechanism configured to hold the closure panel in a closed position when the transportation container is in the closed configuration.

11. The transportation container for a modular fishing rod as claimed in claim 10, wherein the latching mechanism includes a magnetic fastening means.

12. The transportation container for a modular fishing rod as claimed in claim 1, wherein each container insert has a substantially triangular shape.

13. The transportation container for a modular fishing rod as claimed in claim 1, wherein each container insert is made from a foamed plastics material.

14. The transportation container for a modular fishing rod as claimed in claim 1, wherein each container insert has a plurality of spaced apart slots into which modules of a modular fishing rod can be inserted.

15. The transportation container for a modular fishing rod as claimed in claim 14, wherein the spaced apart slots each have slot openings in a first edge or face, and in a second edge or face, of each container insert.

16. The transportation container for a modular fishing rod as claimed in claim 1, wherein each container insert is connectable to the base panel using a hook and loop style fastening system.

17. The transportation container for a modular fishing rod as claimed in claim 1, wherein an inside face of the base panel, the first side panel and the second side panel, are each substantially covered in a material that is suitable for use as a part of a hook and loop style fastening system.

18. The transportation container for a modular fishing rod as claimed in claim 1, wherein the transportation container further includes two end panels, with one end panel being situated at each end of the transportation container, each end panel being configured to provide closure at an end of the transportation container when the transportation container is in the closed configuration.

19. The transportation container for a modular fishing rod as claimed in claim 18, wherein the two end panels form a part of the shell of the transportation container.

20. A modular fishing rod kit incorporating at least one transportation container for a modular fishing rod as claimed in claim 1, and at least one modular fishing rod.
